(19) United States
(12) Patent Application Publication
(10) Pub. No.: US 2020/0065901 A1
(43) Pub. Date: Feb. 27, 2020

(54) SYSTEMS AND METHODS NEGOTIATING A STANDARDIZED FINANCIAL INSTRUMENT BASED ON AN UNSECURED TERM INTEREST RATE

(71) Applicant: Jaiz Investments, Inc., Plano, TX (US)

(72) Inventors: Abhijeet Singh, Plano, TX (US); Zhi Jiang, Plano, TX (US)

(21) Appl. No.: 16/548,591

(22) Filed: Aug. 22, 2019

Related U.S. Application Data
(60) Provisional application No. 62/722,317, filed on Aug. 24, 2018.
(60) Provisional application No. 62/728,464, filed on Sep. 7, 2018.
(60) Provisional application No. 62/754,802, filed on Nov. 2, 2018.

(51) Int. Cl. G06Q 40/04; G06Q 40/02; G06Q 40/06

(52) U.S. Cl. CPC G06Q 40/04; G06Q 40/06; G06Q 40/025

(57) ABSTRACT

In accordance with the principles of the present invention, systems and methods for trading and clearing term interest rate financial instruments that lead to the discovery of spot term interbank interest rate is provided. Multiple exchange-traded financial instrument (e.g., financial derivatives) are proposed that eliminate dependency on published rates that are based on hypothetical borrowing rates or expert judgments. Trade information from these new financial instruments can be used to estimate term unsecured interest rates that are robust and accurately reflect the cost of borrowing in the unsecured markets. This new rate can be used to price various other financial instruments and be a replacement for LIBOR.

### CROSS-REFERENCE TO RELATED APPLICATIONS

This application claims the benefit of U.S. Provisional Application No. 62/722,317, filed Aug. 24, 2018, entitled “Systems And Methods Of Designing Derivative Contracts That Facilitate Discovery Of Term Interest Rates,” U.S. Provisional Application No. 62/728,464, filed Sep. 7, 2018, entitled “Systems And Methods Of Designing Derivative Contracts That Facilitate Discovery Of Term Interest Rates,” U.S. Provisional Application No. 62/741,262, filed Oct. 4, 2018, entitled “Systems And Methods Of Designing Derivative Contracts That Facilitate Discovery Of Term Interest Rates,” U.S. Provisional Application No. 62/745,816, filed Oct. 15, 2018, entitled “Systems And Methods Of Designing Derivative Contracts That Facilitate Discovery Of Term Unsecured Funding Rates,” and U.S. Provisional Application No. 62/745,802, filed Oct. 15, 2018, entitled “Systems And Methods Of Designing Derivative Contracts That Facilitate Discovery Of Term Unsecured Funding Rates.” The entire content of each of the above-referenced applications is incorporated herein by reference.

### FIELD OF INVENTION

The present invention relates to financial instruments and to the electronic trading, clearing and settling of such financial instrument and to the methodology of extracting unobservable information (e.g. Term Interest Rates) about financial markets.

### BACKGROUND OF THE INVENTION

Various financial instruments and commodities trade all over the world and different derivatives are traded on these instruments reflecting the hedging needs of market participants. Typical examples of such derivatives are futures and options on stocks and stock indices. Futures and Options on US government bonds are also traded on exchanges.

An exchange refers to a marketplace where securities, commodities, derivatives and other financial instruments are traded. The core function of an exchange is to ensure fair and orderly trading and the efficient dissemination of price information for any securities trading on that exchange.

Clearing houses refers to an intermediary between buyers and sellers of financial instruments. It is responsible for settling trading accounts, clearing trades, collecting and maintaining margin monies, regulating delivery of the bought/sold instrument, and reporting trading data. Clearinghouses act as third parties to all futures and options contracts, as buyers to every clearing member seller, and as sellers to every clearing member buyer.

Third party custodian is an entity that holds a security that is linked to a contract or a contractual obligation between two parties. An example of this is in tri-party repo agreement transaction where the collateral is held with a third party. A central clearing entity, banks or central banks can act as third party custodian.

A futures and options contract refers to a standardized contract traded and centrally cleared on a derivatives exchange. An example of a futures contract is futures on the Standard & Poor's index of the 500 largest U.S. publicly traded companies (the S&P 500 Index) traded on the Chicago Mercantile Exchange (or the CME Group, located at 20 South Wacker Drive, Chicago, Ill., 60606). This contract expires periodically (e.g., quarterly) into cash as the price of S&P 500 on the designated expiration dates. The CME Group also lists options on the S&P 500 futures index.

An underlying is a financial instrument that is the basis of pricing a derivative contract. It is the basis of settlement of the derivative contract at expiration. In the case of the S&P 500 Index traded futures, the underlying contract is the S&P 500 Index.

A derivative contract on expiration can either be cash settled of physical delivered. For cash settled contract at expiration, the holder of the contract is credited or debited the difference between their entry price and settlement price. For a physical delivered contract, the seller of the contract on expiration is obliged to deliver to the buyer the commodity as specified in the terms of the derivative contract.

A term interest rate refers to a fixed interest rate charged by the lender for a fixed time of a loan. For example, a three month term interest rate is a cost of borrowing funds for three months. A term interest rate forward or a futures contract refers to a term interest rate at some point in the future.

A debt refers to an agreement between a borrower and a lender whereby the borrower is able to borrow money under the conditions of the agreement that is to be paid back to the lender at a later date usually with interest. Common forms of debt include mortgages and credit card loans for individuals, while corporations and governments issue debt in forms of bonds ranging from a few week term to 30 year term or longer.

A zero bond refers to a debt contract where a buyer pays a discounted value of the face value of the bond and the seller promises to pay the buyer the face value of the bond at the end of the term of the bond. No coupon of interest is paid by the seller during the term of the bond.

US Treasury bill or just Treasury bill refers to a debt issued by the treasury department of United States government. They have a maturity of less than 1 year.

An interest rate swap is a derivative contract that exchanges fixed rate interest obligation with a floating rate obligation between the counterparties. An issuer of swap could be a public or private corporation that issues bonds to finance its expenses, while the other side of the swap could be assumed by an investment bank or a hedge fund.

London Inter-Bank Offer Rate (LIBOR) refers to an unsecured rate at which banks can expect to borrow funds from one another. In 1986 the British Bankers Association (the BBA), a trade body backed by the Bank of England, assumed the task of overseeing the calculation of LIBOR. LIBOR is calculated using submissions from a syndicate of banks of a term interest rate at which they think they can borrow funds on the day of submission. Libor is not based on an actual transaction; it is instead an average of expectation of individual bank in the syndicate about the rate at which they can borrow funds in the market. After the financial crisis of 2008, in 2014 the Intercontinental Exchange Group (the ICE) Benchmark Administration Limited (the IBA) became administrator of LIBOR.

Eurodollar Derivative Contract (Eurodollar) refers to a standardized future of options contract traded at the CME Group. This contract is cash settled and the final settlement price is a term LIBOR published on the last trading day (expiration day) of the contract. In the 1980's, the CME Group working alongside the BBA launched the Eurodollar futures contract. This contract made is possible for investment banks and hedge funds to hedge their swap agreements. The underlying contract for the Eurodollar contract is LIBOR then administered by the BBA, now under the jurisdiction of the IBA.

Federal Funds (also FF, or Fed Funds) futures are financial contracts based on the market opinion of the daily official federal funds rate during the contract period. The contract is a proxy for the Federal Reserve's monetary policy expectation. The futures contracts are traded on the CME Group and are cash settled on the last business day of every month.

Hedging refers to offsetting risks of loss from owning a financial obligation due to unforeseen market events. When an investment bank or a hedge fund assumes a contractual obligation of a swap agreement, they want to hedge their exposure to sudden change in the interest rates.

Borrower refers to an individual or entity who issues debt and receives credit/funds for the issued debt. A lender, on the other hand, refers to an individual or entity delivering credit/funds for the purchased debt.

A credit default swap (or CDS) refers to a contract that insures the buyer of the contract against default or a credit event on a corporate or government debt.

Liquidity premium refers to a premium demanded by investors for financial securities that cannot be easily traded or liquidated in a market.

A credit event refers to a state that leads to revaluation of a debt security. Some such events are bankruptcy, failure to service debt, debt restructuring, repudiation, moratorium, obligation acceleration, and obligation default.

### SUMMARY OF THE INVENTION

The present invention relates to financial instruments and to the electronic trading, clearing and settling of such financial instrument and to the methodology of extracting unobservable information (e.g. Term Interest Rates) about financial markets.

[claims to be added by MHM following final review]

### BRIEF DESCRIPTION OF THE DRAWINGS

FIG. 1 illustrates an example electronic trading system 10 implemented on an exchange. The exchange is connected to various trading systems (e.g., clients 16A-16N) through its networking interface 14 and the orders negotiated are matched on a matching engine 12 on an exchange.

FIG. 2 illustrates an example delivery based financial instrument based on term interest rates negotiated on an exchange.

FIG. 3 illustrates an example interaction between a buyer and a seller of a negotiated financial instrument if traded as a debt issue and intermediated by a third party custodian. This interaction may occur after expiration of the derivative contract.

FIG. 4 illustrates an example interaction between a buyer and a seller of a negotiated financial instrument if traded as a zero coupon bond and intermediated by a third party custodian. This interaction may occur after expiration of the derivative contract.

FIG. 5 illustrates an example interaction between buyers and sellers of the negotiated financial instrument if traded as a value of a Treasury bill and/or a credit default swap on one entity or a group of entities. The Treasury bill (or T-Bill) is delivered by a seller, held with a third party custodian, and exchange of funds is conducted via a central clearing between buyers and sellers at expiration of a negotiated term. Under a no credit event as defined in the specifications of the contract, the third party custodian delivers the Treasury bill to the buyer.

FIG. 6 illustrates an example interaction between buyers and sellers of a negotiated financial instrument if traded as a value of Treasury bill and/or credit default swap on one entity or a group of entities. The Treasury bill is delivered by the seller, held with a third party custodian, and exchange of funds is conducted via a central clearing between buyers and sellers at expiration of a negotiation term. Under a credit event as defined in the specifications of the contract, the third party custodian delivers the Treasury bill back to the seller.

FIG. 7 illustrates an example of mapping time periods of the disclosed financial instrument to that of Federal Funds Futures. This mapping is used to find an implied Federal Funds rate for the overlapping period.

FIG. 8 shows a terms structure of a spread between a financial instruments in the current invention for different expirations, with the term interest rates derived using Federal Funds Futures.

FIG. 9 is a non-limiting example of a hardware infrastructure configuration that can be used to run a system that implements electronic trading and clearing of the disclosed financial instrument. The example of FIG. 9 shows a transfer of funds with all associated debt being aggregated at a third party custodian, and borrowers (e.g., sellers) and lenders (e.g., buyers) interact directly or indirectly (via their clearing houses) with a third party custodian. Additionally, the example of FIG. 9 shows an electronic infrastructure to receive market data and publish periodic spot interest rates for various terms.

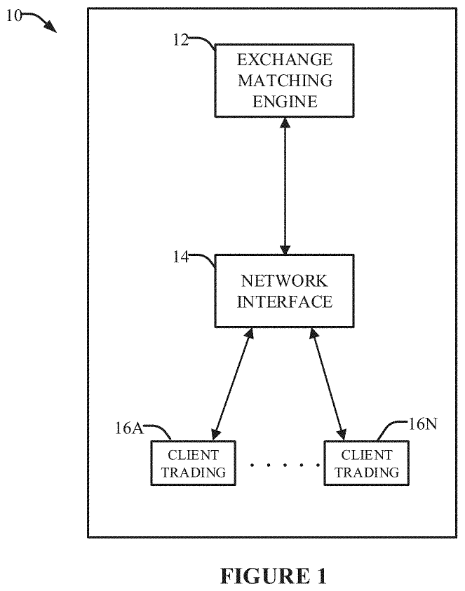

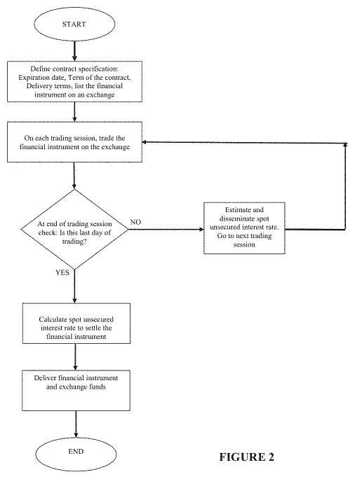

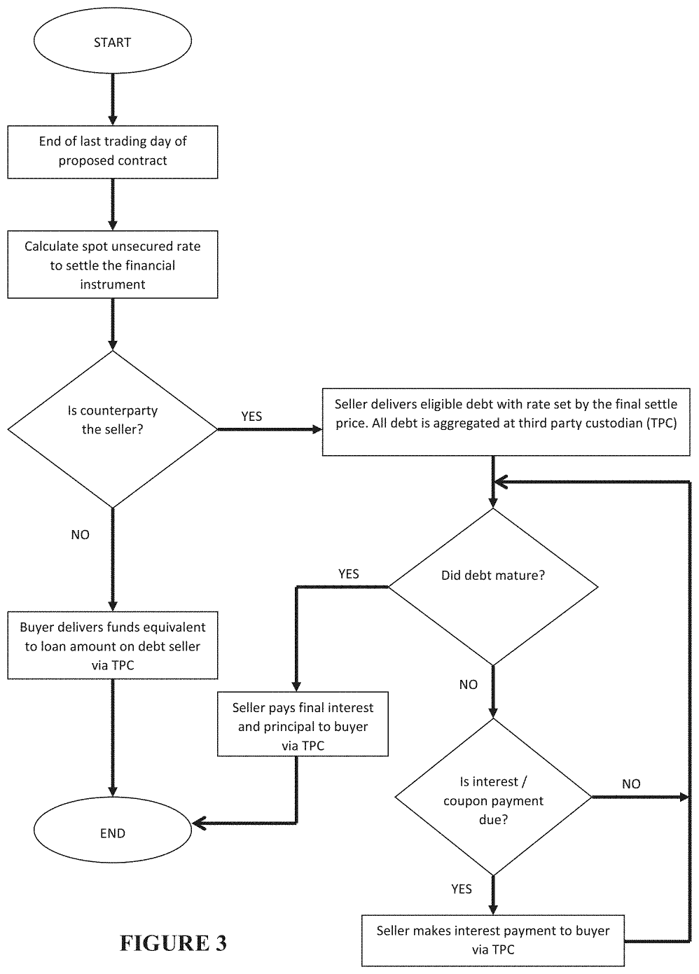

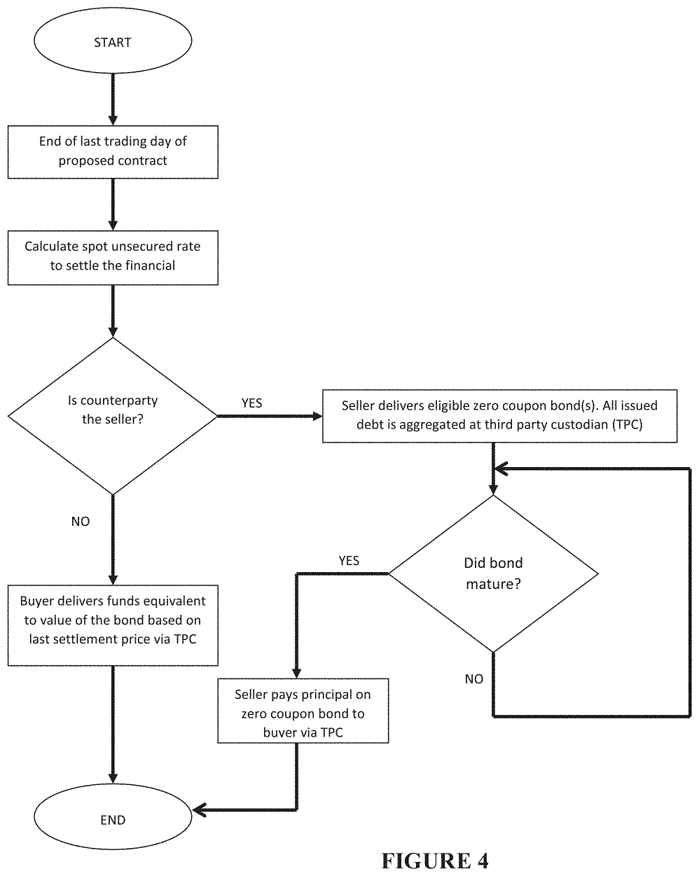

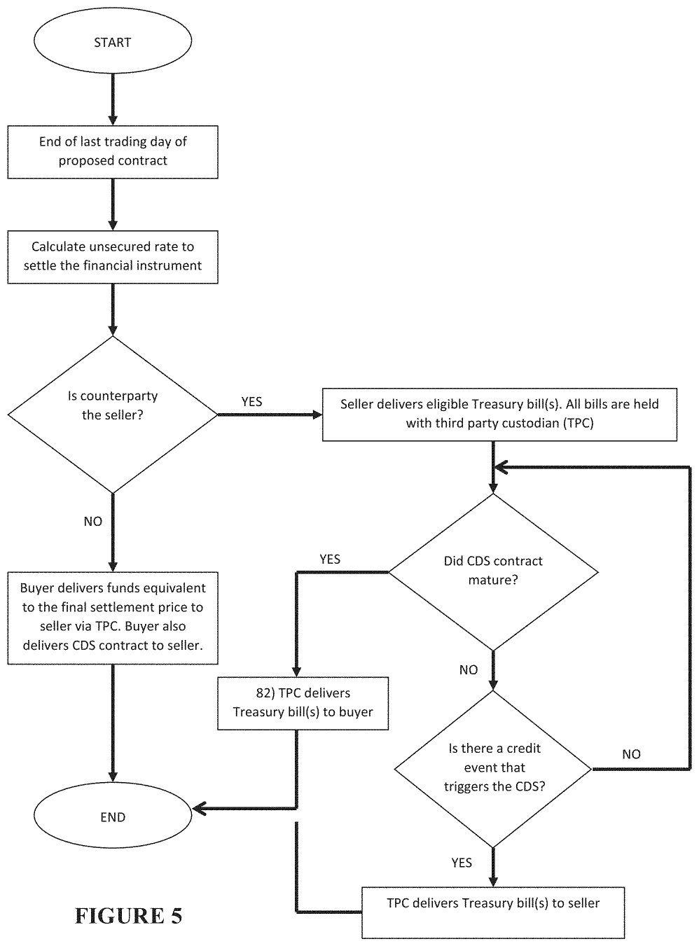

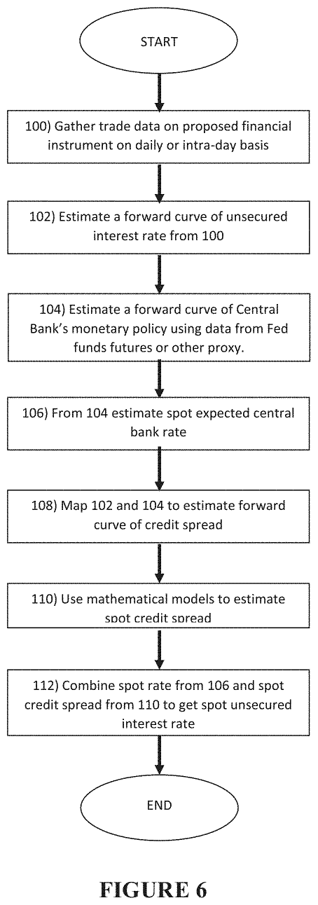

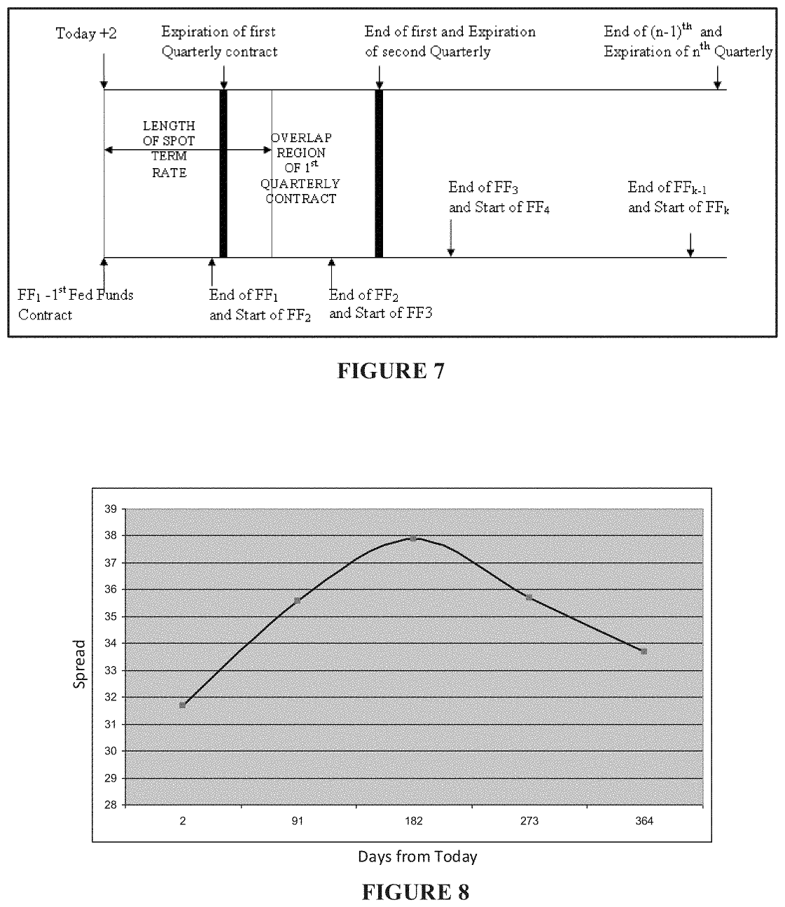

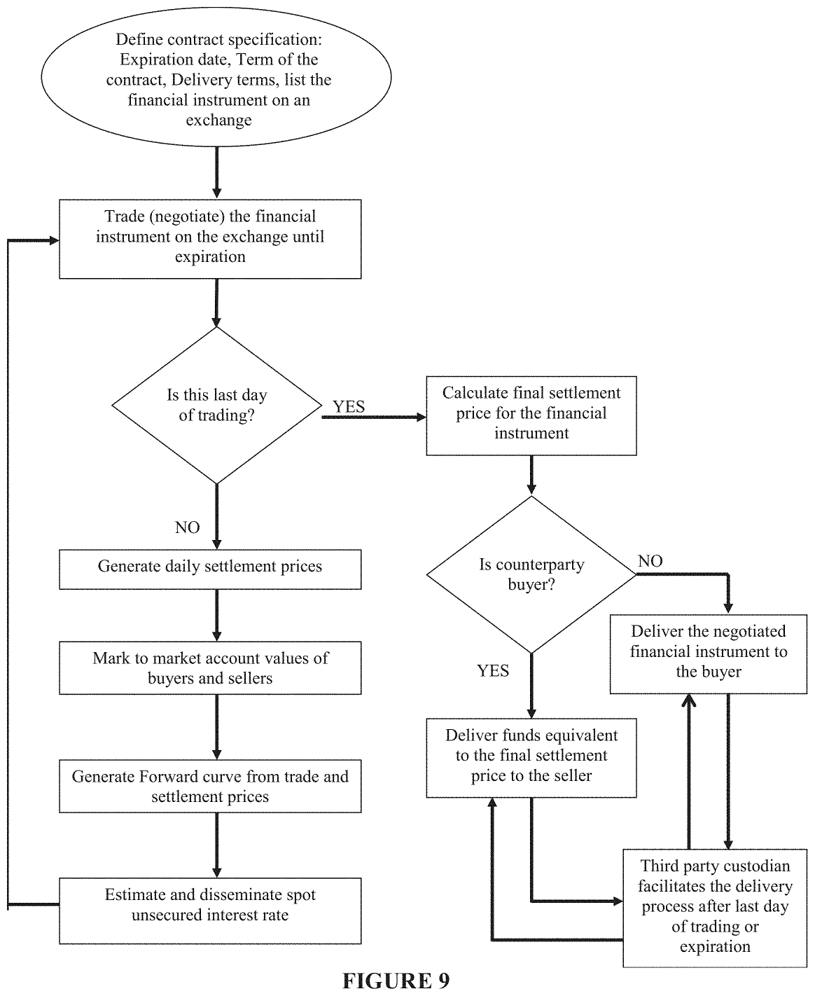

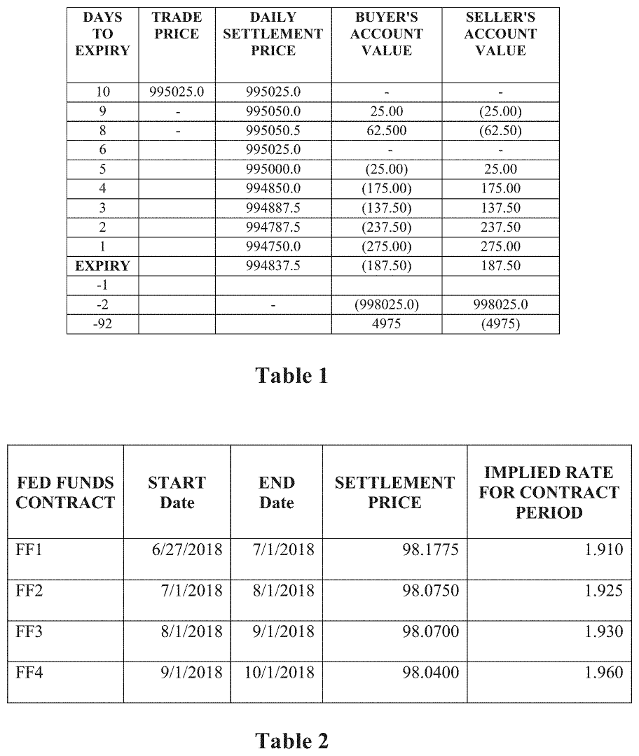

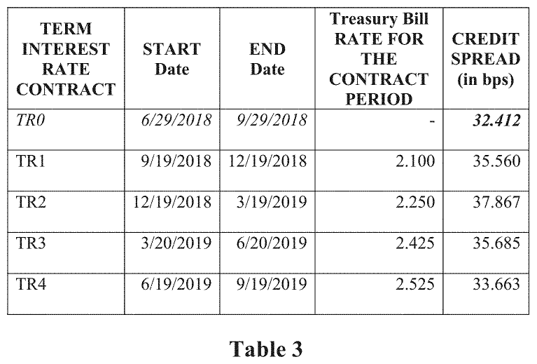

The figures are not necessarily to scale. Where appropriate, similar or identical reference numbers are used to refer to similar or identical components.

### DETAILED DESCRIPTION

The present invention relates to financial instruments and to the electronic trading, clearing and settling of such financial instrument and to the methodology of extracting unobservable information (e.g. Term Interest Rates) about financial markets.

As disclosed herein, the present invention provides a mechanism whereby a financial instrument is negotiated in any of the multiple ways, such as: a) Interest or some function of interest on standardized debt issued at expiration; b) a price of a standardized zero coupon bond issued at expiration; and c) a price of an instrument that delivers a Treasury bill of a certain maturity plus a credit default swap on an entity or group of entities as per contract specification. These financial instruments are used to discover spot unsecured term interest rates.

The disclosed financial instrument is a physical delivered futures contract where a first counterparty (the borrower or seller) delivers the financial instrument to a second counterparty (the lender or buyer) at expiration; and the second counterparty delivers funds associated with debt issued based on the negotiated financial instrument to the first counterparty.

The disclosed financial instrument is negotiated for multiple expirations. The daily settlement price is calculated based on one or more principles set by an exchange upon which the financial instrument is negotiated. In particular, the financial instrument is based on an estimated spot unsecured term interest rate, and not on a manufactured benchmark interest rate, such as LIBOR. Therefore, the terms of the contract that governs the financial instrument are generated in view of the estimated spot unsecured term interest rate, which is calculated from spot term interest rate, which reflects a risk free rate based on central bank policy, and a spot credit spread, which reflects the risk rate of the borrower.

In some examples, a daily settlement price and exchange specific trade information is used to generate a forward price curve. Since the financial instrument reflects terms of unsecured lending, the forward price curve is translated into a forward unsecured interest rate curve, which can be used to calculate the estimated spot unsecured interest rate.

To estimate the spot unsecured interest rate, a forward credit or interest rate curve is generated from an estimate of the forward unsecured interest rate curve. This is done by isolating a particular central bank's (e.g., the Federal Reserve Bank in the U.S.) policy expectation from the forward unsecured interest rate curve. A forward interest rate curve can be estimated from daily settlement prices of the Federal Fund Futures, or the SOFR futures. In some examples, Treasury bills can be used as a proxy for expectations of the Federal Reserve's monetary policy, and used to estimate the forward interest rate curve.

The estimated forward interest rate curve can be modeled using linear or non-linear mathematical models. This fitted model is used to calculate an estimate of a spot credit spread.

The financial instrument is used as a proxy for the respective central bank's monetary policy and can also be used to determine a spot term interest rate. This spot term interest rate can then be added to the estimated spot credit spread to get an estimate of a spot unsecured interest rate, which corresponds to the risk rate of the borrower.

On expiration of the financial instrument, exchange of funds and delivery of the disclosed financial instrument can be done in several ways. Each delivery process is defined in the terms of the negotiated financial instrument and will have an effect on the negotiated price.

In an example, a third party custodian is used to hold the debt delivered by the seller. The delivered debt is held for a period equal to the length, or term, of the lending agreement of the negotiated financial instrument. In this example, the buyer will deliver funds to the seller in exchange for the delivered financial contract that is held with the third party custodian. The seller and buyer interact with the third party custodian to exchange funds, including initial funds, intermediate interest, and/or final principal and interest payments.

In some examples, the financial instrument is negotiated as a combination of a Treasury bill and a credit default swap. In this example, at expiration the seller delivers a Treasury bill to the buyer. However, the Treasury bill is held with a third party custodian for a period equal to the term of the negotiated financial instrument. The buyer delivers funds equal to the price of the negotiated financial instrument at expiration of the settlement price at expiration.

The spot unsecured interest rate is calculated by modeling the term structure of credit risk spread implied by the term interest rates of the financial instrument. In some examples, in determining the settlement price, the term interest rate based on one of a Treasury bill rate or a Federal Funds future rate is added to the calculated spot credit spread. Thus, the spot interest rate can be based on a Treasury bill and/or a Federal Funds future rate.

In some examples, a third party custodian delivers a Treasury bill representing the value of the financial instrument at expiration of the term. In such an example, the buyer of the contract delivers a dollar value of the contract price to the seller of the contract.

In some examples, the negotiated price of the financial instrument to be delivered on expiration is the last settlement price on expiration day. In some examples, the financial instrument may have multiple expirations over a predetermined term.

In some examples, the settlement price on expiration date is the value of the zero coupon bond that the buyer delivers to the seller in exchange for the bond. The zero coupon bond is to be delivered (issued) by the seller of the futures to the buyer at expiration of the term. In some examples, the bond settles two days after the expiration of the futures contract.

In another disclosed example, the financial instrument is a standardized financial derivative having a Treasury bill and a credit default swap as an underlying. The terms of a deliverable financial instrument based on the Treasury bill and the credit default swap are provided in contract specifications. The contract price is the price of a deliverable financial instrument based Treasury bill plus a cost of insuring the financial instrument against one or more credit events. At expiration of the term, the seller delivers the value of the negotiated settlement price to the buyer.

The buyer delivers the Treasury bill underlying the traded financial instrument, which is held at a third party custodian until maturity of the contract agreement (expiration of the term).

In some examples, the negotiated financial instrument includes terms related to actions on occurrence of one or more credit events (e.g., an event that prevents performance of the negotiated contract). If no credit event is triggered by the end of the term of the negotiated financial instrument, the third party custodian delivers the Treasury bill to the buyer. However, if a credit event is triggered before the end of the term, the third party custodian delivers the Treasury bill back to the seller.

Thus, one or more of the financial instruments disclosed herein may be standardized financial contracts with terms set in the contract specification, with the delivery process governed by these specifications.

### Problems Related to LIBOR

Moral Hazard refers to a situation where individuals' or corporations' actions that are at odds with the overall objective of the contract. In the case of LIBOR, during the financial crisis, the participant banks had a negative incentive in posting a higher funding rate that would show their vulnerability and inability to finance their obligations.

Several market participants (traders) at banks colluded with different bank participants to alter their LIBOR submission to affect the outcome of the Eurodollar contract and eventually benefiting from trades on those contracts.

### Usefulness of Unsecured Term Interest Rates

Since the creation of LIBOR and launch of Eurodollar contract, trillions of dollars' worth of financial contracts have been referenced to LIBOR. It has been the basis of pricing swap contract, home mortgages, and other financial obligations. The Eurodollar contract has provided a way for banks to hedge their risk to these contracts.

In the aftermath of the financial crisis, to improve the stability of the financial markets and remove vulnerabilities due to fraud, central banks around the world have been looking for ways to construct benchmark rates that can replace LIBOR. Some of these rates are Secured Overnight Financing Rate (SOFR), Tri-Party General Collateral Rate (TGCR), and Broad General Collateral Rate (BGCR).

SOFR refers to Secured Overnight Funding Rate and is the preferred choice of the Federal Reserve Bank to replace LIBOR. It is a broad measure of the cost of borrowing cash overnight collateralized by Treasury securities. The SOFR includes all trades in the Broad General Collateral Rate plus bilateral Treasury repurchase agreement (repo) transactions cleared through the Delivery-versus-Payment (DVP) service offered by the Fixed Income Clearing Corporation (FICC), which is filtered to remove a portion of transactions considered “specials”(provide ref NYFED website). However, concerns remain if SOFR or any other secured rate could be a viable replacement to LIBOR. Credit risk is an important component of LIBOR and it gives valuable information about the credit conditions in the interbank lending markets. Contrary to LIBOR, SOFR is a secured rate and financial markets have been slow to use it as their preferred benchmark rate and still up to over $200 trillion worth securities are referenced to LIBOR.

### Summary of Financial Innovation

Multiple exchange-traded financial instruments in accordance with the principles of the present invention are disclosed to provide a way to trade long dated futures term interest rate obligations without the need of a benchmark rate like LIBOR.

The present invention permits a market participant to trade a term interest rate forward for a specific expiration date, unwind the contract at a later time or choose to issue or receive the standardized debt upon expiration of the contract.

The present invention provides a mechanism whereby the disclosed financial contract itself is an indicator of term unsecured interest rate and does not depend on the existence of published rate like LIBOR. The term interest rate estimated by this mechanism is based on trading information and is a better representation of inter-bank lending state and therefore a robust replacement of LIBOR.

First of these proposed contracts is a financial instrument (e.g., a financial derivative) with a standardized debt as its underlying. The debt is a standardized credit obligation between a borrower and a lender. The debt is delivered by the seller to the buyer at expiration of the contract at a central location defined in the specifications of the contract.

The disclosed contract is a physical delivered futures contract where one counterparty (the borrower) issues standardized debt to the other counterparty (the lender) and the lender delivers funds to the borrower for the debt. The interest rate or price of debt is negotiated at the time of the trade and marked to market daily. After delivery of the debt on expiration of the contract, the borrower and lender fulfil their obligations as laid out on the debt contract.

In accordance with the principles of the present invention, multiple standardized financial instruments are provided. The financial instruments are marked to market using a daily settlement price based on the principles established by the exchange. The trade data and settlement price from the entire curve of the financial instrument is used to discover a spot term interest rate.

One embodiment of the present invention, a standardized futures contract for issue and purchase of a standardized debt issue of $1 million that has a certain rating certification by a ratings agency; for example, an A-1 rating from Standard & Poor's. The term of debt is three months. The financial instrument is negotiated in terms of 100 minus the three month term interest rate on the debt. The contract is marked to market daily based on settlement prices determined by the exchange where it is traded. The settlement price on expiration date is used to determine the rate paid on the debt issue. The debt issued at expiration settles two days after the expiration of the futures contract. One basis point (0.01%) change in the contract value would represent $25 change in the value of the contract based on a 90 day contract period and a 360 day year.

90/360×1000000×0.0001=$25

Another embodiment of the financial instrument of the present invention, a standardized futures contract for issue and purchase of a zero coupon bond with a face value of $100,000 that has a certain rating certification by a ratings agency; for example, an A-1 rating from Standard & Poor's. The financial instrument is negotiated in terms of the price of bond issued at expiration of the futures contract. The contract is marked to market daily based on settlement prices determined by the exchange where it is traded. The settlement price on expiration date is the value of the zero coupon bond that the buyer delivers to the seller in exchange for the bond. The zero coupon bond is to be delivered (issued) by the seller of the futures to the buyer and term of the bond is three months. This bond settles two days after the expiration of the futures contract.

The delivery of the issued debt of the above embodiments takes place at a third party custodian where all the issued debt for the contract is delivered and aggregated. The buyers transfer the funds to the seller for the debt. The sellers (borrowers) and buyers (lenders) interact directly or indirectly (via their clearinghouses) with the central clearing where the exchange of funds and interest takes place. The buyer of the debt is not delivered one contract worth of debt by the seller, however, the buyer is issued an equivalent part of the entire debt aggregated at a third party custodian.

Another proposed contract is a standardized financial instrument (e.g., a financial derivative) with a Treasury bill(s) and a credit default swap as its underlying (e.g., a Treasury Bill contract). The terms of a deliverable Treasury bill and the credit default swap are provided in contract specifications. The contract price is equivalent to a price of a deliverable Treasury bill plus cost of insuring against a credit event as per contract specification. At expiration the buyer delivers the dollar value of final settlement price of the contract to the seller. The seller delivers a Treasury bill, which is held at a third party custodian until maturity of the contract agreement underlying the traded financial instrument. If no credit event is triggered during the term of the agreement, the third party custodian delivers the Treasury bill to the buyer at the end of the term of the contract. However, if there is a credit event then the third party custodian delivers the Treasury bill back to the seller. This contract emulates a forward lending agreement that gives a price of unsecured interest rate and in effect eliminating a need of a published rate like LIBOR.

The disclosed Treasury Bill contract is a physical delivered futures contract where one counterparty (the seller) delivers a Treasury bill of certain maturity and principal which is held with a third party custodian until the end of the term of the contract. The buyer pays the settlement price of the contract at expiration to the seller. If there is no credit event during the term of the contract, the third party custodian delivers this Treasury bill to the other counterparty (the buyer). In case there is a credit event during the term of the contract the third party custodian delivers the Treasury bill back to the seller. The negotiated value of the contract is a function of price of Treasury bill, the cost of insuring against credit events and a liquidity premium. The price of the negotiated contact at the time of the trade is marked to market daily.

In accordance with the principles of the present invention, multiple standardized financial instruments are provided. The financial instrument is marked to market using a daily settlement price based on the principles established by the exchange. The trade data and settlement price from the entire curve of the financial instrument is used to discover a spot term interest rate.

The framework provided with respect to the disclosed Treasury Bill contract allows for credit default swaps (CDS) to be traded between two counterparties on an exchange. The design of such a contract would require the seller to deliver a Treasury bill with a certain maturity and principal. The contract also specifies a credit event that pertains to debt or entity for which the credit risk is priced. At expiration, the seller delivers the Treasury bill, which is held with a third party custodian entity. The buyer pays the settlement price of the contract at expiration to the seller. At the end of the term of the contract, if no credit event is triggered, the third party custodian delivers the Treasury bill to the buyer. On the other hand, if there is a credit event the seller is delivered back the Treasury bill.

An alternate unsecured funding rate can be calculated by using prices of these exchange traded CDS futures for different banks in the LIBOR basket and estimating a spot funding rate for each of those banks. Once there is an estimate of spot interest rate for each of these banks, the LIBOR methodology can be applied to estimate an alternate unsecured funding rate.

One embodiment of the present invention, a standardized futures contract for a delivery of a 3-month Treasury bill (hereinafter, the first 3-month Treasury Bill) with a maturity equal to or less than that of the contract period and a total face value of $1,000,000 at the time of expiration. The contract defines a set of 10 prime banks that underlie criteria of a credit event. The contract specifies a credit event for each of the bank in the set. If no credit event is triggered during the term of the contract after expiration, the third party custodian delivers the Treasury bill(s) to the buyer. If one bank experience credit event then 90% of the treasury or face value of $900,000 worth of Treasury bill is delivered to the buyer and face value of $100,000 worth of Treasury bill is delivered to the seller. Similarly, if n banks experience credit event then face value of (1-n/10) % of $1,000,000 of treasury is delivered to the buyer and the remaining treasury is delivered to the seller. This exchange is done through the third party custodian that holds the treasury bills until the maturity of the contract.

Another embodiment of the above proposed contract, a standardized futures contract for a delivery of a 3-month Treasury bill (hereinafter, the second 3-month Treasury Bill) with a maturity equal to or less than that of the contract period and a total face value of $100,000 at the time of expiration. The contract defines a list of prime banks that underlie criteria of a credit event. The contract specifies a credit event is triggered if more than 25% of the set of prime banks listed on the contract experience a credit event. If no credit event is triggered during the term of the contract after expiration, the third party custodian delivers the Treasury bill to the buyer. If there is a credit event triggered then the third party custodian delivers the Treasury bill back to the seller.

Another embodiment of the present invention is a standardized futures contract for a delivery of a 3-month Treasury bill (hereinafter, the third 3-month Treasury Bill) with a maturity equal to or less than that of the contract period and a total face value of $100,000 at the time of expiration. The contract also specifies delivery of a credit default swap for that period on a sine entity ABCD bank LLC. The contract specifies that is a credit event on ABCD bank LLC is triggered then the third party custodian delivers Treasury bill is delivered to the seller of the contract. If no credit event is triggered during the term of the contract after expiration, the third party custodian delivers the Treasury bill to the buyer.

Using an embodiment of the first 3-month Treasury Bill as described above, a hypothetical daily price of four immediate quarterly futures contracts is used to describe a methodology to discover a spot term interest rate.

The term interest rate implied by the negotiated value of the financial instrument provided in the present invention will broadly reflect the level of forward term interest rates of treasury curve, the cost of insurance against the credit event according to contract specifications plus a liquidity premium. To isolate this credit risk spread we take the difference between the negotiated rate implied by the financial instrument and the cheapest deliverable Treasury bill. Here, for simplicity the credit risk rate, which is a total of credit risk premium and liquidity premium, is modeled together. The two can be separated and modeled independently to get a better representation of market expectations.

To estimate spot unsecured interest rate we need a spot credit risk rate. This spot credit risk rate can be obtained by modeling the term structure of credit risk spread implied by term interest rates of the financial instrument. Finally, the spot unsecured interest rate can be calculated by adding the spot credit spread (or spot credit risk spread) to the term interest rate implied by the Federal Reserve's policy. The expectation of the Federal Reserve's policy is embedded in the Treasury bill rate. Federal Funds future can also be used to get an estimate of the Federal Reserve's policy.

In this example, we use Federal Funds futures as a proxy for the Federal Reserve's interest rate policy and for the calculation of spot term interest rate. Using Treasury bill to estimate spot term interest rate will generate different results as compared with using Federal Funds futures.

The difference between the Term Interest Rate implied by the disclosed financial instrument and the equivalent risk free rate gives the credit risk spread. The credit risk spread is calculated for four expirations. This is one embodiment of the term structure of credit spread. Using this estimated credit spread curve, we can discover spot credit spread. There are many ways to discover the spot credit spread. Below we show two ways:

A spot credit spread (CS₀) is discovered by a linear interpolation of the implied credit spread of expired closest to the current date (CS₋₁) and the implied credit spread from the next available contract closest to the current date (CS₁).

$${CS}_{0} = \frac{{t}_{1} {CS}_{- 1} + {t}_{- 1} {CS}_{1}}{{t}_{- 1} + {t}_{1}}$$

Here, t₋₁ is the number of days from the current date and first expired contract closest to the current date and t₁ is the number of days from the current date to the first active contract.

Another way to model credit spread is to fit a parametric equation like one below

CSₜ=A₀+A₁*e^{(-A}₂^{*t)}+A₃*e^{(-A}₄^{*t)}

Here, CSₜ is the implied credit spread from all available contracts; t is the number of days between the current date and the contract. Finally, A₀, A₁, A₂, A₃, A₄ are estimated by fitting credit spreads calculated above, using this model.

The spot credit spread at t=0 is calculated as:

CS₀=A₀+A₁+A₃

This spot credit spread (CS₀) calculated is added to the implied spot term Federal Funds rate from the FF futures curve to get the spot term unsecured interest rate.

The process of estimating the spot term unsecured interest rate above can be used to get an estimate of the borrowing ability of an entity, when the financial contract is designed based on the third 3-month Treasury Bill. If there are multiple futures contracts based on the third 3-month Treasury Bill, the futures contract can be based on all the banks in a LIBOR panel applying a similar methodology to the term interest rates calculated for each of these banks to generate an unsecured interest rate.

### Example

Examples, made with reference to Tables 1-3, show implementation of quarterly physical delivered term interest rate futures and calculation of spot term interest rate using the daily settlement prices of term interest rate futures and fed fund futures. This term interest future is negotiated in terms of the price of the face value of $100,000 of Treasury bill delivered at expiration with a credit default event stated in the contract. This term interest rate future with the nearest quarterly expiration is negotiated at a price of $995,025 between a buyer and a seller. The length of term of the issued debt is 90 days. The debt is settled two days after expiration. The tick price of the contract is $12.5.

Table 1 lists scenarios of daily settlement prices of this contract until expiration and changes in the account values at the clearinghouse of the buyer and the seller from mark to market of the contract.

After expiration, Table 1 shows changes in Account Value of Buyer and Seller from delivery of the Treasury bill under no credit event trigger.

For this example, the current date is Jun. 27, 2018. Table 3 shows credit spread between the embodiment of the financial instrument of the present invention and the Treasury bill of the equivalent period. Denote TR0 as the spot term interest rate that we wish to estimate. The term of TR0 is from Jun. 29, 2018 to Sep. 29, 2018. Denote TR1 the contract that expired on Jun. 18, 2018, the credit spread of TR1 estimated at expiration was 32.15; this credit spread is historical data and is therefore fixed. One embodiment of the calculation of credit spread for TR0 is calculated as follows:

$$TR 0 credit spread = \frac{82 * 32.15 + 9 * 35.56}{91} = 32.49 bps ( 0.3249 \% )$$

Using Table 2 we can find the implied FF rate for the period of TR0 for the period starting Jun. 29, 2018 and ending on Sep. 29, 2018 equal to 1.937%.

$$TR 0 = \frac{2 * 1.91 + 31 * 1.925 + 31 * 1.93 + 28 * 1.96}{92} = 1.937 \%$$

The spot term interest rate for period starting Jun. 29, 2018 and ending Sep. 29, 2018=implied FF rate for the period+estimated credit spread/100:

1.937+e=2.262%

One day calculation of term spot interest rate from settlement prices of term interest rate future and Federal Funds Futures are shown in Table 2:

The present methods and systems may be realized in hardware, software, and/or a combination of hardware and software, including circuits, circuitry, transceivers, wired and wireless communication networking capabilities. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether the performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A method for negotiating a standardized financial instrument based on an unsecured term interest rate, the method comprising:
calculating, on the at least one processor, a daily settlement price at one or more expirations of the financial instrument based at least on one or more principles set by an exchange upon which the financial instrument is negotiated and an estimated spot unsecured term interest rate;
calculating, on the at least one processor, the estimated spot unsecured term interest rate based on a spot term interest rate reflecting a central bank policy rate and a spot credit spread reflecting a borrowers credit risk;
generating, on at least one processor, an unsecured interest rate curve representative of the daily settlement prices over a term of the financial instrument;
calculating, on at least one processor, the spot unsecured term interest rate electronically rate based on the unsecured interest rate curve;
negotiating the financial instrument between a seller and a buyer, wherein an interest rate of the financial instrument is negotiated at the time of contracting based on the spot unsecured term interest rate; and
delivering a commodity or currency having a value associated with the negotiated financial instrument via a central clearinghouse upon expiration of the term.

2. The method of claim 1, further comprising:
generating a forward price curve based on the daily settlement price or exchange specific trading information; and
calculating, on the one or more processors, the estimated spot unsecured interest rate by translating the forward price curve into a forward unsecured interest rate curve by isolating one or more policy rates of the central bank from the forward unsecured interest rate curve such as the daily settlement price.

3. The method of claim 2, wherein the forward interest rate curve is modeled using a linear or a non-linear mathematical model fitted estimate the spot credit spread

4. The method of claim 2, wherein further comprising calculating the spot unsecured interest rate by adding the spot term interest rate to the spot credit spread which corresponds to the risk rate of the borrower.

5. The method of claim 1, further comprising:
calculating the spot interest rate for different terms; and
publishing the calculated spot interest rate at one or more times within a defined time period.

6. The method of claim 1, further comprising disseminating the calculated spot interest rate over one or more networks.

7. The method of claim 1, further comprising trading the financial instrument as a price of zero coupon bond issued by the seller at expiration of the term.

8. The method of claim 1, further comprising transferring the financial instrument to the seller, wherein the seller delivers the zero coupon bond.

9. The method of claim 1, wherein the negotiated price of the financial instrument to be delivered on expiration is a last daily settlement price at expiration of the term.

10. The method of claim 1, further comprising aggregating all debt issued by the sellers of financial instrument at expiration of the term at the third party custodian.

11. The method of claim 1, wherein the seller makes interest payments on a value of debt associated with the financial instrument prior to expiration of the term.

12. The method of claim 1, further comprising proportionally distributing, from the third party custodian, the interest payments to the buyer.

13. The method of claim 1, wherein the value of the financial instrument is delivered in dollar amounts.

14. A method for negotiating a standardized financial instrument based on an unsecured term interest rate, the method comprising:
calculating, on the at least one processor, a daily settlement price at one or more expirations of the financial instrument based at least on one or more principles set by an exchange upon which the financial instrument is negotiated and an estimated spot unsecured term interest rate;
calculating, on the at least one processor, the estimated spot unsecured term interest rate based on a spot term interest rate reflecting a central bank policy rate and a spot credit spread reflecting a borrowers credit risk;
generating, on at least one processor, an unsecured interest rate curve representative of the daily settlement prices over a term of the financial instrument;
calculating, on at least one processor, the spot unsecured term interest rate electronically rate based on the unsecured interest rate curve;
negotiating the financial instrument between a seller and a buyer, wherein an interest rate of the financial instrument is negotiated at the time of contracting based on a spot unsecured term interest rate the underlying for this instrument is a combination of a standardized Treasury bill and a credit default swap;
monitoring, on the processor, for one or more credit events;
delivering the Treasury bill having a value associated with the negotiated financial instrument to the seller via a central clearing house when a credit event is triggered; and
delivering, at expiration of the financial instrument, the Treasury bill having a value associated with the negotiated financial instrument to the buyer via a central clearinghouse if no credit event is triggered.

15. The method of claim 14, wherein the one or more credit events is associated with one or more entities, each entity being assigned a percentage of the whole of the one or more entities according to one or more of value, relevance, or investment, with respect to the financial instrument.

16. The method of claim 14, further comprising:
detecting a credit event associated with an entity of the one or more entities;
determining a percentage of the whole assigned to the entity; and
delivering the Treasury bill having a value associated the percentage of the whole assigned to the entity associated with the credit event

17. The method of claim 14, further comprising delivering a credit default swap to the seller from the buyer via the central clearinghouse.

18. A system comprising a processor and memory, the memory storing program code including instructions to negotiate a standardized financial instrument based on an unsecured term interest rate, the system executing the instructions to, at least:
calculate, on the at least one processor, a daily settlement price at one or more expirations of the financial instrument based at least on one or more principles set by an exchange upon which the financial instrument is negotiated and an estimated spot unsecured term interest rate;
calculate, on the at least one processor, the estimated spot unsecured term interest rate based on a spot term interest rate reflecting a central bank policy rate and a spot credit spread reflecting a borrowers credit risk;
generate, on the at least one processor, an unsecured interest rate curve representative of the daily settlement prices over a term of the financial instrument;
calculate, on at least one processor, the spot unsecured term interest rate electronically rate based on the unsecured interest rate curve;
negotiate the financial instrument between a seller and a buyer, wherein an interest rate of the financial instrument is negotiated at the time of contracting based on the spot unsecured term interest rate; and
deliver a commodity or currency having a value associated with the negotiated financial instrument via a central clearinghouse upon expiration of the term.
